(19) United States
(12) Patent Application Publication
(10) Pub. No.: US 2007/0085887 A1
(43) Pub. Date: Apr. 19, 2007

(54) Ink jet pigment ink formulations and systems

(76) Inventors: Kai-Kong Iu, San Diego, CA (US); Rodney D. Stramel, San Diego, CA (US); Dennis Z. Guo, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,698

(22) Filed: Oct. 18, 2005

(51) Int. Cl. G01D 11/00; C09D 11/02

(52) U.S. Cl. 347/100; 106/31.6; 106/31.89; 106/31.75; 106/31.68

(57) ABSTRACT

Self-dispersed pigment ink formulations and systems employing the same are disclosed.

### BACKGROUND

The use of inkjet printing systems in offices and homes has grown dramatically in recent years. The growth can be attributed to drastic reductions in cost of inkjet printers and substantial improvements in print resolution and overall print quality. While the print quality has drastically improved, research and development efforts continue toward improving the permanence of inkjet images because this property still falls short of the permanence produced by other printing and photographic techniques. A continued demand in inkjet printing has resulted in the need to produce images of high quality, high permanence, and high durability, while maintaining a reasonable cost.

In inkjet printing, the inkjet image is formed on a print medium when a precise pattern of dots is ejected from a drop-generating device known as a printhead. The typical inkjet printhead has an array of precisely formed nozzles located on a nozzle plate and attached to an inkjet printhead array. The inkjet printhead array incorporates an array of firing chambers that receive liquid ink, which includes pigment-based inks and/or dye-based inks dissolved or dispersed in a liquid vehicle, through fluid communication with one or more ink reservoirs. Each chamber has a thin-film resistor, known as a firing resistor, located opposite the nozzle so ink can collect between the firing resistor and the nozzle. Upon energizing of a particular firing resistor, a droplet of ink is expelled through the nozzle toward the print medium to produce the image.

One of the challenges in pigment based inks is keeping the pigment well dispersed in the ink vehicle while the vehicle is evaporating at the exposed print head nozzles. If the pigment settles out after the vehicle is evaporated, the settling pigment particles will distort the first drop trajectory and causes print defects such as text and line quality.

### SUMMARY

Briefly described, embodiments of this disclosure include ink-jet pigment ink formulations, ink-jet ink sets, printer systems, and methods of printing. One exemplary ink-jet pigment ink formulation, among others, includes a pigment, and a hydrotrope. The amount of hydrotrope is about 0.01 to 15 weight % of the ink-jet pigmented ink formulation.

An exemplary printer system, among others, includes a dispensing system including at least one printhead, wherein the printhead includes at least one of a ink-jet pigmented ink formulation, and wherein the ink-jet pigmented ink formulation includes: a pigment, and a hydrotrope, wherein the amount of hydrotrope is about 0.01 to 15 weight % of the ink-jet pigmented ink formulation.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an embodiment of a printer system.

FIG. 2 is an illustration of an image of a plot of inks using the time delay written on the right side of the illustration according to an embodiment of the invention.

FIGS. 3A and 3B illustrate close up images at about 2.8 seconds of the control ink (FIG. 3A) and the ink spiked with 0.125% SXS (Ink C in table 2) (FIG. 3B) according to an embodiment of the invention.

FIG. 4 illustrates a close up image at about 11.1 seconds of the 0.125% SXS spiked ink (Ink C in table 2) according to an embodiment of the invention.

### DETAILED DESCRIPTION

Ink-jet pigment ink formulations are described. Embodiments of the ink-jet pigment ink formulation include a pigment and a hydrotrope. Although not intending to be bound by theory, the hydrotropes added to the ink formulation may eventually adsorb onto the free surface of the pigment particle to give extra dispersing power to the pigment particle. The extra dispersing power is utilized when the vehicle components are evaporating at the exposed print head nozzles, in order to keep the pigment particle dispersed in the ink solution.

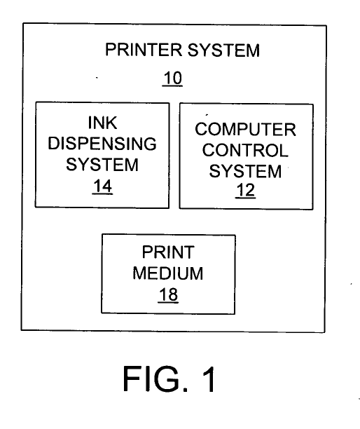

FIG. 1 illustrates a block diagram of a representative printer system 10 that includes a computer control system 12, an ink dispensing system 14, and a print medium 18. The computer control system 12 includes a process control system that is operative to control the ink dispensing system 14. In particular, the computer control system 12 instructs and controls the ink dispensing system 14 to print characters, symbols, photos, etc. onto the print medium 18.

The ink dispensing system 14 includes, but is not limited to, ink-jet technologies and coating technologies, which dispense the ink (e.g., pigment-based ink formulations) onto the print medium 18. Ink-jet technology, such as drop-on-demand and continuous flow ink-jet technologies, can be used to dispense the ink. The ink dispensing system 14 can include at least one ink-jet printhead system (e.g., thermal ink-jet printhead. and/or a piezo ink-jet print head) operative to dispense (e.g., jet) the inks through one or more of a plurality of nozzles in a printhead. The term “plurality” as used herein refers to both one or more and a multitude. The printhead system incorporates an array of firing chambers that receive the ink (e.g., a black self-dispersed pigment ink formulation) dissolved or dispersed in a liquid vehicle, which are in fluid communication with one or more ink reservoirs.

The terms “print media” or “print medium” can include, but are not limited to, a paper substrate, a photobase substrate, a plastic media (e.g., clear to opaque plastic film) substrate, and the like. The print media may include, but are not limited to, a hard or flexible material made from a polymer, a paper, a glass, a ceramic, a woven cloth, or a non-woven cloth material.

As mentioned above, the ink-jet pigment ink formulation includes, but is not limited to, a pigment and a hydrotrope. The hydrotrope maybe adsorbed onto the free surface of the self-dispersed pigment. In addition, the ink-jet pigment ink formulation can include a vehicle such as one including salts, a solvent, an aqueous solution, buffers, biocides, binders, and combinations thereof.

The ink-jet pigmented ink formulation improves the first drop-out performance. The ink-jet pigmented ink formulation has an optical density (OD) from about 1.2 to 1.6 on plain paper.

The pigment can be a black or color self-dispersed pigment. As used herein, the term “self-dispersed pigment” is meant to be understood broadly as any pigment that can be dispersed in a liquid vehicle without the aid of dispersion. A “self-dispersed pigment” is typically a pigment whose surface has been chemically modified to make it dispersible in a liquid vehicle. These chemical modifications include surface oxidation and surface attachments with small molecules or polymers that contain chargeable groups and nonionic polyoxyalkylenated or polyoxyarylenated groups. The self-dispersed pigment can be of any color used in the ink-jet arts. Though any color can be used, black carbon pigments are described in an exemplary manner to favorably set forth certain principles of the present system and method.

Depending on nature of the chargeable groups of the surface attachments, the self-dispersed pigment can either be anionic or cationic. The common anionic chargeable groups include, but are not limited to, carboxylate, sulfonate, and combinations thereof. The common cationic chargeable group includes amine and quaternary ammonium. Depending also on the nature of the chargeable groups of the surface attachments, the common cationic counter ion includes, but is not limited to, sodium, potassium, lithium, ammonium, tetraalkyl ammonium, and combinations thereof. The common anionic counter ion includes, but is not limited to, chloride, sulphate, phosphate, and combinations thereof.

One method of forming the self-dispersed black pigment includes treating the self-dispersed black pigment precursor with aryl diazonium salts containing at least one acidic functional group. Examples of aryl diazonium salts include those prepared from sulfanilic acid, 4-aminobenzoic acid, 4-aminosalicylic acid, 7-amino-4-hydroxy-2-naphthlenesulfonic acid, aminophenylboronic acid, aminophenylphosphonic acid, and metanilic acid.

Self-dispersed black pigment inks and methods of attaching functionalized groups are described in U.S. Pat. Nos. 5,707,432; 5,630,868; 5,571,311; and 5,554,739, all of which are incorporated herein by reference.

The following self-dispersed black pigments are useful in the practice of this disclosure; however, this listing is merely illustrative and not intended to limit the disclosure. The following self-dispersed black pigment inks are commercially available from Cabot: Cab-O-Jet® 200, Cab-O-Jet® 300. The following base black pigments are available from Columbian: Raven 7000, Raven 5750, Raven 5250, Raven 5000, and Raven 3500. The following black pigments are available from Degussa: Color Black FW 200, Color Black FW 2, Color Black FW 2V, Color Black FW 1, Color Black FW 18, Color Black S 160, Color Black FW S 170, Special Black 6, Special Black 5, Special Black 4A, Special Black 4, Printex™ U, Printex™ 140U, Printex™ V, and Printex™ 140V. Tipure™. R-101 is available from DuPont.

In an embodiment, the self-dispersed pigment includes a 4-amino benzoic acid (PABA) modified pigment, a sulfanilic acid (SA), a 5-amino isophthalic acid (ISO) modified pigment, a 4-amino phthalic acid (4APA) modified pigment, and a 5-amino-1, 2, 3-benzenetricarboxylic acid (Triacid) modified pigment. In particular, the self-dispersed pigment is a 5-amino-1, 2,3-benzenetricarboxylic acid (Triacid) modified pigment. In addition, the self-dispersed pigment includes amino benzene derivatives capable of reacting with HNO₂ acid in a diazonium reaction with the base pigment.

Hydrotropes are characterized by their ability to solubilize water-insoluble organic compounds such that the resulting isotropic solution occupies a relatively large area in the phase diagram and has a relatively high surface tension in comparison to that of solutions made by the use of surfactants.

The hydrotrope may be anionic, cationic, or non-ionic. Embodiments where the pigment is anionic, the hydrotrope can be anionic, non-ionic, or a combination thereof. Embodiments where the pigment can be cationic, the hydrotrope is cationic, non-ionic, or a combination thereof. Embodiments where the pigment is nonionic, the hydrotrope can be anionic, cationic, non-ionic, zwitterionic, or a combination thereof. For example, when the self-dispersed pigment is a SA modified pigment, a PABA modified pigment, a ISO modified pigment, a 4APA modified pigment, or a Triacid modified pigment, the hydrotrope is anionic or non-ionic.

Anionic hydrotropes include, but are not limited to, salts of benzoic acid, salts of salicylic acid, salts of benzene acid, salts of benzene disulfonic acid, salts of toluene sulfonic acid, salts of xylene sulfonic acid, salts of cumene sulfonic acid, salts of cymene-sulfonic acid, salts of cinnamic acid, salts of octane sulfonic acid, salts of hexane sulfonic acid, salts of butane sulfonic acid, and salts of decane sulfonic acid. The cation associated with these salts may be Na⁺, K⁺, Li₊, or NH₄⁺. Preferably, the anionic hydrotrope is sodium xylene sulfonate, sodium salicylate, or sodium benzoate.

In addition, the anionic hydrotropes can include anionic dye-based colorants such as, but not limited to, C. I. Direct Black 19, Pacified C. I. Reactive Black 31, C.I. Direct Black 168, 22, 32, 38, 51, 56, 71, 74, 75, 77, 154, and 171. and C. I. Food Black 1 and 2, and combinations thereof.

Non-ionic hydrotropes include, but are not limited to, natural sugars (e.g., D-fructose, glucose, and the like), resorcinol, and pyrogallol.

Cationic hydrotropes include, but are not limited to, p-amino benzoic acid hydrochloride, procaine hydrochloride, caffeine; and salts of alkylpyridium, alkyltrimethyl ammonium, benzyltrialkyl (C1 to C4) ammonium, and phenyltrimethyl ammonium cations. The anion associated with these salts may be any of the halides, particularly C1.

The amount of hydrotrope added into the ink-jet pigment ink formulation may be about 0.01 to 15 weight % of the ink-jet pigment ink formulation, about 0.05 to 12 weight %, and about 0.1 to 8 weight % of the ink-jet pigment ink formulation.

The solvent can include, but is not limited to, water soluble organic solvents. The water soluble organic solvents can include, but are not limited to, aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones.

For example, the solvent can include, but is not limited to, primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides.

In particular, the solvent can include, but is not limited to, ethoxylated glycerol; 2-methyl-1,3-propanediol; 2-methyl 2,4-pentanediol; 1,5-pentanediol; 2-pyrrolidone; 1-(2-hyd roxylethyl )-2-pyrrolidinone; 2-ethyl-2-hydroxymethyl-1,3-propanediol; diethylene glycol; 3-methoxybutanol; and 1,3-dimethyl-2-imidazolidinone. The solvent can also include, but is not limited to, 1,2-hexanediol; 1,2-octainediol; 2,5-dimethyl-3-hexyne-2,5-diol; trimethylol propane, 3-hexnye-2,5-diol; sulfolane; 3-pyridyl carbinol; and other pyrridine derivatives. In addition, the solvents can be added to reduce the rate of evaporation of water in the ink-jet to minimize clogging or other properties of the ink such as viscosity, pH, surface tension, optical density, and print quality.

The salt can include, but is not limited to, ammonium, potassium, or lithium benzoate salts; ammonium, potassium, or lithium acetates; lithium, potassium, or lithium xylene sulfonate salts; nitrates of NH₄, sodium, lithium, and potassium; lactates of ammonium, potassium, or lithium; citrates of ammonium, potassium, or lithium; carbonates of sodium, lithium, and potassium; diphosphates of sodium, lithium, and potassium; triphosphates of sodium, lithium, and potassium; and mixtures thereof. In addition, the salt can include sodium, lithium, and potassium salts of compounds such as, but not limited to, citrate, succinate, lactate, formate, gluconate, tartarate, malonate, fumarate, malate, sebacate, laurate, glutarate, acetate, oxylate, adipicate, pimelicate, subericate, azelaicate, and mixtures thereof.

Various buffers or pH adjusting agents can also be optionally used in the ink formulation. The buffering agent can include, but are not limited to, hydroxides of alkali metals and amines (e.g., lithium hydroxide, sodium hydroxide, potassium hydroxide, and citric acid); amines (e.g., triethanolamine, diethanolamine, and dimethylethanolamine); hydrochloric acid; and other basic or acidic components which do not substantially interfere with the bleed control or optical density characteristics. In addition, commercially available pH buffers can also be used and are available from Sigma Aldrich (e.g., MES, MOPs, Trizma, Bis-Tris, MOPSO, TES, TAPSO, TEA, TRICINE, BICINE, TAPS, and AMPSO, in the acid or salt form).

Various biocides can be used to inhibit growth of undesirable microorganisms. The biocides can include, but are not limited to, benzoate salts, sorbate salts, commercial products such as NUOSEPT™ (Nudex, Inc., a division of Huls America), UCARCIDE™ (Union Carbide), VANCIDE (RT Vanderbilt Co.), and PROXEL™ (ICI Americas), and other biocides.

Various surfactants can be used in the ink formulation. The surfactant can include, but are not limited to, anionic, non-ionic, and zwitterionic surfactants. The anionic surfactant can include, but is not limited to, sodium or potassium salts of straight chain fatty acids; sodium and potassium salts of coconut oil fatty acids; sodium and potassium salts of tall oil fatty acids; amine salts; acylated polypeptides; linear alkyl benzene sulfonates; higher alkyl benzene sulfonates; benzene; toulene; xylene; cumenesulfonate; lignosulfonates; petroleum sulfonates; N-acyl-n-alkyltaurates; paraffin sulfonates; secondary n-alkanesulfonates; alpha olefin sufonates; sulfosuccinic esters; alkyl naphalene sulfonates; isethionates; sulfuric acid ester salts; sulfated polyoxyethylenated straight-chain alcohols; sulfated triglycerides oils; phosphoric and polyphosphoric acid esters; and perfluorinated anionic surfactants.

The non-ionic surfactant can include, but is not limited to, alkylphenol ethoxylates, polyoxyethylenates, straight chain alcohols ethoxylates, polyoxyethylenated polyoxypropylene glycols, polyoxyethylenated mercaptans, long chain carboxylic acid esters, glyceryl and polyglyceryl esters of natural and fatty acids, propylene glycol, sorbitol and polyoxyethylenated sorbitol esters, polyoxyethylene glycol esters and polyoxyethylenated fatty acids, aklanolamine condensates, alkanolamides, tertiary acetylenic glycols, polyoxyethylenated silicones, N-alkylprrrolidones, and alkylpolyglycosides.

The zwifterionic surfactant can include, but is not limited to, beta-N-alkylaminopropionic acids, N-alkyl-beta-iminodipropionic acids, imidazoline carboxylates, N-alkylbetaines, amine oxides, sulfobetaines, and sultaines surfactants.

In addition, binders can be included in the ink formulation, which act to secure the ink on the print medium. The binders can include, but are not limited to, compounds having molecular weight (MW) of from about 200 MW to about 100K MW. The binders can include, but are not limited to, polyester, polyester-melanine, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and salts thereof.

The ink-jet pigment ink formulation can include an amount of the pigment from about 1 to 6 weight percent of the formulation. The ink-jet pigment ink formulation can include an amount of hydrotrope from about 0.01 to 15 weight percent of the formulation. The remaining portion of the ink-jet pigment ink formulation includes the vehicle and/or other components.

In an embodiment, the ink-jet pigment ink formulation can include an amount of the self-dispersed pigment (e.g., Triacid) of about 4.5 weight percent of the formulation and include an amount of hydrotrope (e.g., sodium xylene sulfonate) of about 0.125% weight percent of the formulation, while the remaining portion is a vehicle.

In another embodiment, the ink-jet pigment ink formulation can include an amount of the self-dispersed pigment (e.g., Triacid) of about 4.5 wt. % of the formulation and include an amount of hydrotrope (e.g., D-fructose) of about 7 wt. % of the formulation, while the remaining portion is a vehicle.

In another embodiment, the ink-jet pigment ink formulation can include an amount of the self-dispersed pigment (e.g., Triacid) of about 4.5 wt. % of the formulation and include an amount of hydrotrope (e.g., Direct Black 19) of about 1.5 wt. % of the formulation, while the remaining portion is a vehicle.

In another embodiment, the ink-jet pigment ink formulation can include an amount of the self-dispersed pigment (e.g., Triacid) of about 4.5 wt. % of the formulation and include an amount of hydrotrope (e.g., Pacified Reactive Black 31) of about 2 wt. % weight percent of the formulation, while the remaining portion is a vehicle.

The ink-jet pigment ink formulation can be used in conjunction with one or more color inks in an ink-jet ink set in a printer system 10. The ink-jet pigment ink formulation and the one or more color inks can be used in the same printhead or in one or more printheads.

The color ink can include, but is not limited to, dye-based inks and pigment-based inks. The dye-based inks and pigment-based inks may be nonionic, cationic, anionic, or mixtures thereof. Color dye-based inks and pigment-based inks for use in ink-jet printing may be employed in the practice of this disclosure. The color inks can include a large number of water-soluble acid and direct dyes. For the purposes of clarification only, and not for limitation, some exemplary colorants suitable for this purpose are set forth below.

Specific examples of such dyes include the Pro-Jet series of dyes available from Avecia Ltd., including Pro-Jet Yellow I Direct Yellow 86, Acid Red 249, Direct Blue 199, Direct Black 168, and Direct Yellow 132; Aminyl Brilliant Red F-B (Sumitomo Chemical Co.); the Duasyn line of “salt-free” dyes available from Hoechst, such as Reactive Black 31, Direct Yellow 157, Reactive Yellow 37, Acid Yellow 23, Reactive Red 180, Acid Red 52, and Acid Blue 9; mixtures thereof; and the like. Further examples include Tricon Acid Red 52, Tricon Direct Red 227, and Tricon Acid Yellow 17 (Tricon Colors Incorporated), Bernacid Red 2BMN, Pontamine Brilliant Bond Blue A, BASF X-34, Pontamine, Food Black 2, Catodirect Turquoise FBL Supra Conc. (Carolina Color and Chemical), Direct Blue 86, (Mobay Chemical), Reactive Red 4, Aldrich Chemical), Reactive Red 56, Pylam, Inc., Levafix Brilliant Red E4B (Mobay Chemical), Levafix Brilliant Red E-6BA (Mobay Chemical), Pylam Certified D&C Red #28 (Pylam), Direct Brill Pink B Ground Crude (Crompton & Knowles), Cartasol Yellow GTF Presscake (Sandoz, Inc.), Tartrazine Extra Conc. (Sandoz, Inc.), Direct Yellow 86, Carolina Color and Chemical, Cartasol Yellow GTF Liquid Special 110 (Sandoz, Inc.), D&C Yellow #10 (Tricon), Yellow Shade 16948 (Tricon), Basacid Black X34 (BASF), Carta Black 2GT (Sandoz, Inc.), Neozapon Red 492 (BASF), Orasol Red G (Ciba-Geigy), Direct Brilliant Pink B (Crompton-Knolls), Aizen Spilon Red C-BH (Hodagaya Chemical Company), Kayanol Red 3BL (Nippon Kayaku Company), Levanol Brilliant Red 3BW (Mobay Chemical Company), Levaderm Lemon Yellow (Mobay Chemical Company), Aizen Spilon Yellow C-GNH (Hodagaya Chemical Company), Spirit Fast Yellow 3G, Sirius Supra Yellow GD 167, Cartasol Brilliant Yellow 4GF (Sandoz), Pergasol Yellow CGP (Ciba-Geigy), Orasol Black RL (Ciba-Geigy), Orasol Black RLP (Ciba-Geigy), Savinyl Black RLS (Sandoz), Dermacarbon 2GT (Sandoz), Pyrazol Black BG (ICI Americas), Morfast Black Conc A (Morton-Thiokol), Diazol Black RN Quad (ICI Americas), Orasol Blue GN (Ciba-Geigy), Savinyl Blue GLS (Sandoz, Inc.), Luxol Blue MBSN (Morton-Thiokol), Sevron Blue 5GMF (ICI Americas), and Basacid Blue 750 (BASF); Levafix Brilliant Yellow E-GA, Levafix Yellow E2RA, Levafix Black EB, Levafix Black E-2G, Levafix Black P-36A, Levafix Black PN-L, Levafix Brilliant Red E6BA, and Levafix Brilliant Blue EFFA, all available from Bayer; Procion Turquoise PA, Procion Turquoise HA, Procion Turquoise Ho5G, Procion Turquoise H-7G, Procion Red MX-5B, Procion Red H8B, Procion Red MX 8B GNS, Procion Red G, Procion Yellow MX-8G, Procion Black H-EXL, Procion Black P-N, Procion Blue MX-R, Procion Blue MX-4GD, Procion Blue MX-G, and Procion Blue MX-2GN, all available from ICI Americas; Cibacron Red F-B, Cibacron Black BG, Lanasol Black B, Lanasol Red 5B, Lanasol Red B, and Lanasol Yellow 46, all available from Ciba-Geigy; Baslien Black P-BR, Baslien Yellow EG, Baslien Brilliant Yellow P-3GN, Baslien Yellow M-6GD, Baslien Brilliant Red P-3B, Baslien Scarlet E-2G, Baslien Red E-B, Baslien Red E-7B, Baslien Red M-5B, Baslien Blue E-R, Baslien Brilliant Blue P-3R, Baslien Black P-BR, Baslien Turquoise Blue P-GR, Baslien Turquoise M-2G, Baslien Turquoise E-G, and Baslien Green E-6B, all available from BASF; Sumifix Turquoise Blue G, Sumifix Turquoise Blue H-GF, Sumifix Black B, Sumifix Black H-BG, Sumifix Yellow 2GC, Sumifix Supra Scarlet 2GF, and Sumifix Brilliant Red 5BF, all available from Sumitomo Chemical Company; Intracron Yellow C-8G, Intracron Red C-8B, Intracron Turquoise Blue GE, Intracron Turquoise HA, and Intracron Black RL, all available from Crompton and Knowles, Dyes and Chemicals Division; mixtures thereof, and the like. This list is intended to be merely exemplary, and should not be considered limiting.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications may be made to the above-described embodiments. All such modifications and variations are intended to be included herein within the scope of this disclosure and protected by the following claims.

### EXAMPLE 1

Experimental:

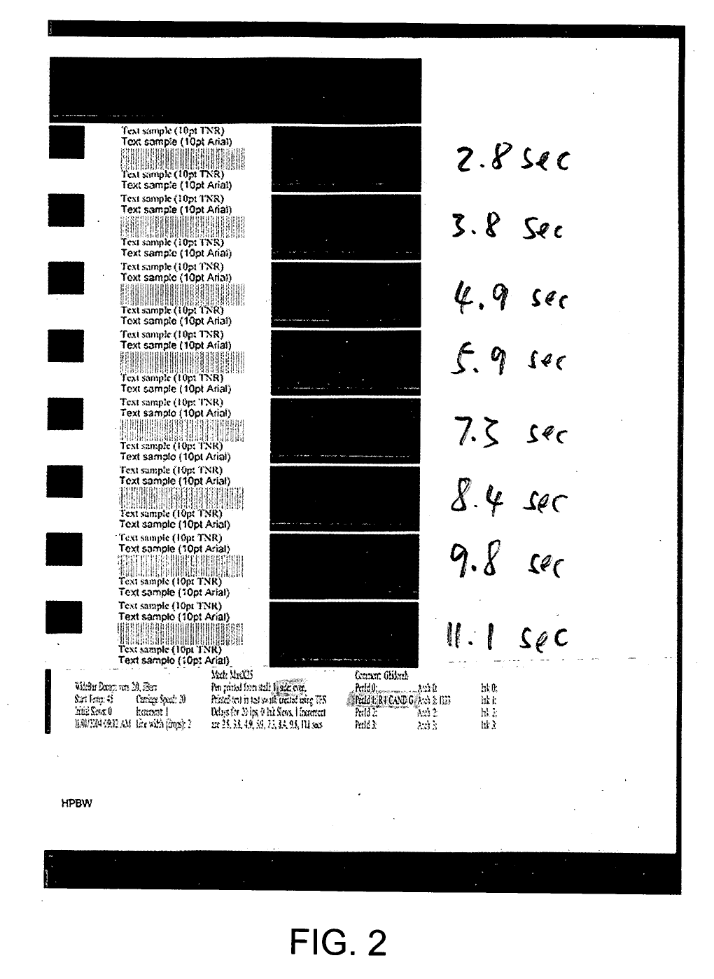

The black pigment is a triacid modified pigment. All black inks use about 4.5% of black pigment load in a common vehicle (Table 1) and the pH of the inks is around 8.5. The inks are filled in an inkjet pen and printed using the same configuration. FIG. 2 is an illustration of an image of the plot using the time delay written on the right side. The SMA1440 is from Sartomer and all other chemicals are purchased from Aldrich. The commercial TIJ grade dye concentrates of Direct Black 19 (DB19) and Pacified Reactive Black 31 (PRB31) are obtained from H. W. Sands corp. and Sencient respectively.

The spiking of the black dye used the 1/10 k dilution Absorbance value at maximum absorption wavelength in the final ink. Other hydrotropes spiking used the weight % as stated in the first column.

TABLE 1
Common vehicle formulation.

| Chemical | Weight % |
|---|---|
| 2-Pyrrolidone | 3-10 |
| Tris(hydroxymethyl)aminomethane. | 0.05-0.5 |
| LEG-1 | 1-4 |
| 1,5 Pentanediol | 1-6 |
| 10% aqueous SMA1440 potassium | 1-20 |
| solution | |
| 2-Methyl-1,3-propanediol | 1-6 |
| Surfynol 465 | 0.05-0.5 |
| Zonyl FSO | 0.001-0.2 |

Results:

Table 2 summarizes the test results on the control ink and the inks spiked with different hydrotropes. Since the pigment carries anionic charge, the spiked hydrotropes are either anionic or non-ionic. For the anionic series, Direct Black 19 (DB19) and Pacified Reactive Black 31 (PRB31) are the anionic black dyes. In addition, sodium xylene sulfonate (SXS) is used as a hydrotrope. The non-ionic hydrotrope in this study is a natural sugar (e.g., D-fructose).

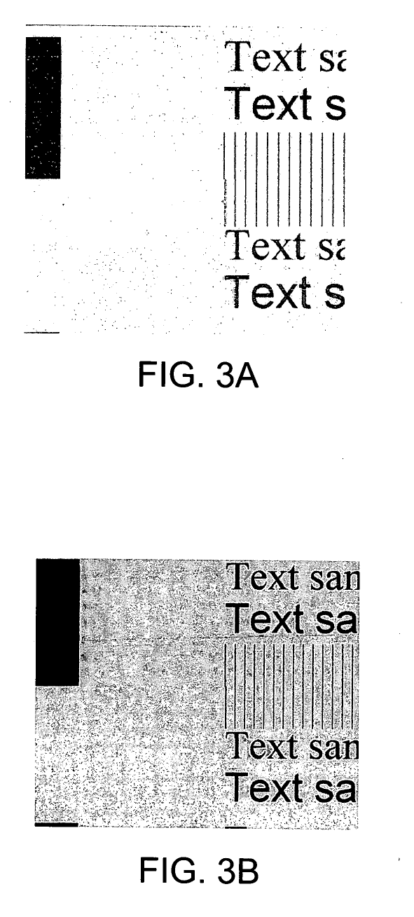

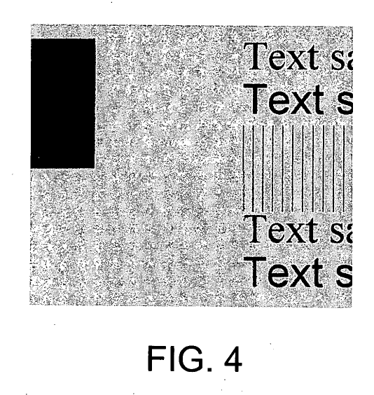

In Table 2, all the inks spiked with hydrotropes improve the first Drop out performance without significant decrease in the OD and increase in the viscosity. FIGS. 3A and 3B illustrate close up images at 2.8 seconds of the control ink (FIG. 3A) and the ink spiked with 0.125% SXS (Ink C) (FIG. 3B). FIG. 4 illustrates a close up image at 11.1 second of the 0.125% SXS spiked ink (Ink C). FIG. 3A is the close up image of the control ink at a 2.8 second time delay, the top section of this image of 2 lines of text and a series of vertical lines are without any time delay. The bottom section of the vertical lines and 2 lines of text are with certain time delay (e.g., a 2.8 second in FIG. 3A). This image reveals the control ink already showing degradation on the line (spraying) and text quality (losing edge sharpness) at 2.8 seconds.

However, the ink spiked with 0.125% of SXS (Ink C) shows no degradation at a 2.8 seconds delay as shown in FIG. 3B. In fact, this ink gives better line and text quality than the control ink at 2.8 second time delay even at the maximum time delay of the test plot which is 11.1 seconds (compare FIG. 3A vs. FIG. 4).

TABLE 2
First Drop-out, average OD and viscosity of the test inks spiked with
different hydrotropes.

| | | Avg. OD on | |
|---|---|---|---|
| | First | HPMP, UCGW | Viscosity |
| | Drop-out | (ink flux ˜72 ng/ | @ 25 C. |
| Ink name | (in sec) | 300 dpi | and 60 rpm (in cps) |
| Control | <2.8 | 1.43 | 2.74 |
| Ink A: Control | 7.3 | 1.50 | 4.17 |
| plus ˜2 wt. % | | | |
| PRB 31 | | | |
| Ink B: Control | 9.8 | 1.47 | 2.7 |
| plus ˜1.5 wt. % | | | |
| DB16 | | | |
| Ink C: Control plus | 9.8 | 1.50 | 2.5 |
| 0.13 wt. % SXS | | | |
| Ink D: Control | 7.4 | 1.33 | 2.21 |
| plus 7% Fructose | | | |

### CONCLUSION

By introducing hydrotropes such as SXS, DB19, PRB31 and D-20 Fructose into Triacid black pigment ink, the first Drop Out performance improves significantly. The improved first Drop Out performance provides good line and text quality at speed.

1. An ink-jet pigmented ink formulation, comprising:
a pigment, and
a hydrotrope, wherein the amount of hydrotrope is about 0.01 to 15 weight % of the ink-jet pigmented ink formulation.

2. The ink-jet pigmented ink formulation of claim 1, wherein the pigment is a self-dispersed pigment.

3. The ink-jet pigmented ink formulation of claim 2, wherein the self-dispersed pigment is anionic and is selected from one of the following: 4-amino benzoic acid (PABA) modified pigment, 5-amino isophthalic acid (ISO) modified pigment, 4-amino phthalic acid (4APA) modified pigment, and 5-amino-1, 2, 3-benzenetricarboxylic acid (Triacid) modified pigment.

4. The ink-jet pigmented ink formulation of claim 3, wherein the hydrotrope is selected from the following: an anionic hydrotrope and a non-ionic hydrotrope.

5. The ink-jet pigmented ink formulation of claim 4, wherein the anionic hydrotrope is selected from the following: salts of benzoic acid, salts of salicylic acid, salts of benzene acid, salts of benzene disulfonic acid, salts of toluene sulfonic acid, salts of xylene sulfonic acid, salts of cumene sulfonic acid, salts of cymene-sulfonic acid, salts of cinnamic acid, salts of octane sulfonic acid, salts of hexane sulfonic acid, salts of butane sulfonic acid, salts of decane sulfonic acid, and combinations thereof.

6. The ink-jet pigmented ink formulation of claim 4, wherein the anionic hydrotrope is selected from the following: anionic dye-based colorants and natural sugars.

7. The ink-jet pigmented ink formulation of claim 2, wherein the self-dispersed pigment is selected from an oxidized carbon black, a surface modified carbon black, and a combination of oxidized and surface modified carbon black.

8. The ink-jet pigmented ink formulation of claim 2, wherein the self-dispersed pigment is selected from an oxidized color pigment, a surface modified color pigment, and a combination of oxidized and surface modified color pigment.

9. The ink-jet pigmented ink formulation of claim 1, wherein the hydrotrope is selected from the following: a cationic hydrotrope and a non-ionic hydrotrope.

10. The ink-jet pigmented ink formulation of claim 9, wherein the hydrotrope is selected from the following: p-amino benzoic acid hydrochloride, procaine hydrochloride, caffeine; salts of alkylpyridinium, salts of alkyltrimethyl ammonium, salts of benzyltrialkyl (C1 to C4) ammonium, and salts of phenyltrimethyl ammonium cations;
resorcinol, and pyrogallol.

11. The ink-jet pigmented ink formulation of claim 1, wherein the hydrotrope is selected from the following: salts of benzoic acid, salts of salicylic acid, salts of benzene sulfonic acid, salts of benzene disulfonic acid, salts of toluene sulfonic acid, salts of xylene sulfonic acid, salts of cumene sulfonic acid, salts of cymene sulfonic acid, salts of cinnamic acid, salts of octane sulfonic acid, salts of hexane sulfonic acid, salts of butane sulfonic acid, salts of decane sulfonic acid, p-amino benzoic acid hydrochloride, procaine hydrochloride, caffeine, salts of alkylpyridium, salts of alkyltrimethyl ammonium, salts of benzyltrialkyl (C1 to C4) ammonium, salts of phenyltrimethyl ammonium cations, resorcinol, and pyrogallol.

12. The ink-jet pigmented ink formulation of claim 1, wherein the self-dispersed pigment is in an amount from about 1 to 6 weight percent of the self-dispersed pigment ink formulation, the hydrotrope is in an amount from about 0.01 to 15 weight percent of the self-dispersed pigment ink formulation, and a vehicle comprises the remainder of the amount of the self-dispersed pigment ink formulation.

13. The ink-jet pigmented ink formulation of claim 1, wherein the self-dispersed pigment is anionic and the hydrotrope is selected from an anionic hydrotrope, a nonionic hydrotrope, and combinations thereof.

14. The ink-jet pigmented ink formulation of claim 1, wherein the self-dispersed pigment is cationic and the hydrotrope is selected from a cationic hydrotrope, a nonionic hydrotrope, and combinations thereof.

15. The ink-jet pigmented ink formulation of claim 1, wherein the self-dispersed pigment is nonionic and the hydrotrope is selected from an anionic hydrotrope, a cationic hydrotrope, a nonionic hydrotrope, a zwiterionic hydrotrope, and combinations thereof.

16. A printer system, comprising:
a dispensing system including at least one printhead, wherein the printhead includes at least one of an ink-jet pigmented ink formulation, wherein the ink-jet pigmented ink formulation includes:
a pigment, and
a hydrotrope, wherein the amount of hydrotrope is about 0.01 to 15 weight % of the ink-jet pigmented ink formulation.

17. The printer system of claim 16, wherein the pigment is a self-dispersed pigment.

18. The printer system of claim 17, wherein the self-dispersed pigment is selected from one of the following: 4-amino benzoic acid (PABA) modified pigment, 5-amino isophthalic acid (ISO) modified pigment, 4-amino phthalic acid (4APA) modified pigment, and 5-amino-1, 2, 3-benzenetricarboxylic acid (Triacid) modified pigment.

19. The printer system of claim 18, wherein the hydrotrope is selected from the following: an anionic hydrotrope and a non-ionic hydrotrope.

20. The printer system of claim 19, wherein the anionic hydrotrope is selected from the following: salts of benzoic acid, salts of salicylic acid, salts of benzene acid, salts of benzene disulfonic acid, salts of toluene sulfonic acid, salts of xylene sulfonic acid, salts of cumene sulfonic acid, salts of cymene-sulfonic acid, salts of cinnamic acid, salts of octane sulfonic acid, salts of hexane sulfonic acid, salts of butane sulfonic acid, salts of decane sulfonic acid, and combinations thereof.

21. The printer system of claim 19, wherein the anionic hydrotrope is selected from the following: anionic dye-based colorants and natural sugars.

22. The printer system of claim 17, wherein the self-dispersed pigment is selected from an oxidized carbon black, a surface modified carbon black, and a combination of oxidized and surface modified carbon black.

23. The printer system of claim 17, wherein the self-dispersed pigment is selected from an oxidized color pigment, a surface modified color pigment, and a combination of oxidized and surface modified color pigment.

24. The printer system of claim 17, wherein the dispensing system includes a color ink is selected from a pigment-based ink, a dye-based ink, and combinations thereof.
